(19) United States
(12) Patent Application Publication
(10) Pub. No.: US 2002/0192550 A1
(43) Pub. Date: Dec. 19, 2002

(54) Non-sintered nickel electrode

(75) Inventors: Patrick Bernard, Bordeaux (FR); Lionel Goubault, Merignac (FR); Estelle Gauthier, Lormont (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/133,454

(22) Filed: Apr. 29, 2002

(30) Foreign Application Priority Data
Apr. 30, 2001 (FR) 01 05 802

(51) Int. Cl. H01M 4/62; H01M 4/52

(52) U.S. Cl. 429/217; 429/223

(57) ABSTRACT

A non-sintered electrode includes a metal two-dimensional conductive support and a paste comprising an electrochemically active material containing nickel hydroxide and a binder which is a mixture of an elastomer consisting of a butadiene polymer and an ethylene/vinyl acetate copolymer.

### CROSS-REFERENCE TO RELATED APPLICATIONS

This application is based on French Patent Application No. 01 05 802 filed Apr. 30, 2001, the disclosure of which is hereby incorporated by reference thereto in its entirety, and the priority of which is hereby claimed under 35 U.S.C. §1 19.

### BACKGROUND OF THE INVENTION

1. Field of the Invention

The present invention relates to a non-sintered nickel electrode, in particular a positive electrode for an alkaline electrolyte secondary storage cell.

It relates more precisely to a non-sintered electrode including a metal two-dimensional conductive support and a paste comprising an electrochemically active material containing nickel hydroxide and a binder which is a mixture of an elastomer comprising a butadiene polymer and a second polymer.

2. Description of the Prior Art

There are several types of electrodes, including sintered electrodes and non-sintered electrodes, also referred to as paste electrodes or plasticized electrodes.

Non-sintered electrodes are the most widely used at present. Compared to other electrodes, a non-sintered electrode contains a greater quantity of active material so that its capacity per unit volume is increased and its fabrication cost is reduced.

A non-sintered electrode comprises a support serving as a current collector and coated with a paste containing the active material and a binder, to which a conductive material is usually added. This is conventionally achieved by depositing the paste in a porous three-dimensional conductive support such as metal or carbon felt or foam.

For cost reasons, there is now a trend to using two-dimensional supports.

The document JP-3 165 469 proposes a nickel electrode comprising a two-dimensional porous conductive support, such as a grid, an expanded metal or a perforated metal, covered with a paste including nickel hydroxide, a conductive material and a thermoplastic binder, such as a butylene/ethylene/styrene copolymer To fix the active material to the support, a separator is hot-pressed onto each face of the electrode.

The document EP-0 750 358 describes a non-sintered nickel electrode whose support is a corrugated metal plate on which asperities are formed to attach a layer which is rough on a microscopic scale and is made up of powdered nickel and/or cobalt bound with butadiene-polyvinyl alcohol PVAI. Onto this layer is deposited a paste comprising carboxymethylcellulose CMC and a styrene/butadiene copolymer SBR.

Research has been conducted into improving the mechanical and chemical durability over the prior art, in particular with regard to electrochemical oxidation.

U.S. Pat. No. 6,335,120 proposes a non-sintered nickel electrode with a two-dimensional collector whose binder is a mixture of an elastomer and a crystalline polymer. The elastomer is chosen from a styrene/ethylene-butylene/styrene copolymer SEBS, a styrene/butadiene/vinylpyridine terpolymer SBVR, and a styrene/butadiene copolymer SBR, possibly carboxylated. The crystalline polymer is chosen from a polyolefin such as polyethylene PE and a fluoropolymer such as a fluorocopolymer of ethylene and propylene, polytetrafluoroethylene PTFE and hexafluoropropylene HFP.

It has been found that this kind of fluoropolymer binder does not achieve sufficient electrode adhesion and cohesion and leads to a loss of active material.

Moreover, a binder of this kind has a film-forming behavior leading to irregularities relating to the presence of large quantities of a crystalline polymer with a high melting point.

### SUMMARY OF THE INVENTION

The invention solves this problem, and to achieve this, in accordance with the invention, the binder is a mixture of a butadiene copolymer and an ethylene/vinyl acetate copolymer EVA.

This composition of the binder ensures improved mechanical properties of the electrode, in particular correct elasticity, intergranular cohesion and adhesion to the conductive support.

The EVA is preferably an aqueous dispersion of an ethylene/vinyl acetate copolymer. Polyvinyl alcohol is preferably added to the aqueous solution to stabilize it. The proportion of vinyl acetate in the copolymer is preferably greater than 70 wt %.

In the preferred embodiment, the total amount of binder is from 1 wt % to 3 wt %.

The proportion of butadiene copolymer in the binder is advantageously from 1 0 wt % to 60 wt % and the proportion of ethylene/vinyl acetate copolymer in the binder is advantageously from 40 wt % to 90 wt %.

The butadiene copolymer is preferably a carboxylated styrene/butadiene copolymer SBR.

It is to be understood that the expression “electrochemically active material containing nickel hydroxide” used in this application can refer not only to a nickel hydroxide or a hydroxide containing mainly nickel but also to a nickel hydroxide containing at least one syncrystallized hydroxide of a particular element. A syncrystallized hydroxide contained in the nickel hydroxide is a hydroxide forming a solid solution with the nickel hydroxide, i.e. occupying, in continuously variable proportions, the atomic sites defined by the crystal lattice of the nickel hydroxide.

In this sense, in accordance with the invention, the electrochemically active material containing the nickel hydroxide preferably contains an element chosen from zinc, cadmium and magnesium.

The electrochemically active material containing nickel hydroxide advantageous also contains an element chosen from cobalt, manganese, aluminum, yttrium, calcium, strontium, zirconium, copper, lithium, and sodium.

The nickel hydroxide is preferably spheroidal and has a range of particle sizes from 7 microns to 20 microns.

In the preferred embodiment, the nickel hydroxide is covered with a coating based on cobalt hydroxide, possibly partly oxidized. The coating can further contain elements chosen from nickel, zinc, aluminum and/or magnesium.

The paste can further contain a powdered yttrium compound, preferably an yttrium oxide such as Y₂O₃ or an yttrium hydroxide such as Y(OH)₃.

Nickel hydroxide is a poor conductor and this necessitates the addition of a conductive material to allow good electrical percolation.

The paste advantageously further contains a conductive substance consisting essentially of a cobalt compound, preferably a cobalt oxide such as CoO, metallic cobalt Co or a cobalt hydroxide such as Co(OH)₂.

The paste can equally further contain a powder chosen from zinc oxide and zinc hydroxide.

The expression “two-dimensional support” means a plane support on which a layer of paste is deposited. The properties of the binder are therefore essential for retaining the layer to the support, especially if the finished electrode is rolled up.

The two-dimensional support can be a solid or perforated tape, an expanded metal, a grid or a woven material. For example, it is an expanded nickel support or a nickel-plated steel tape with a thickness from 20 microns to 100 microns.

### DETAILED DESCRIPTION OF A PREFERRED EMBODIMENT

One embodiment of an electrode according to the invention is described hereinafter.

An AA size nickel-metal hydride (Ni-MH) sealed secondary storage cell whose nominal capacity Cn is 1 200 mAh was manufactured in the following manner.

The positive electrode used a paste having the following composition (expressed in wt % with respect to the weight of the paste):

| | |
|---|---|
| electrochemically active material | 92.7% |
| CoO conductive material | 8% |
| EVA binder | 1.5% |
| SBR binder | 0.5% |
| thickener | 0.3% |

The powdered electrochemically active material was a nickel-based hydroxide. The thickener was the sodium salt of hydroxypropylmethylcellulose (HPMC). The viscosity of the paste was adjusted with water. The paste was deposited simultaneously on both sides of a two-dimensional metal support (perforated nickel-plate steel 70 microns thick) in a homogeneous manner. The resulting assembly was then dried for 30 minutes at 80° C. to eliminate water and then rolled to the required thickness for the electrode.

A comparative efficiency test is described hereinafter. The test compared the specific embodiment of the invention described above (cell B), a prior art electrode with a three-dimensional collector and a binder consisting of PTFE (cell A), an electrode with a binder consisting of EVA and SBR in which the proportion of binder is less than 1 wt % (cell C), and an electrode with a binder comprising EVA and SBR in which the proportion of binder is greater than 3 wt % (cell D).

The first reference positive electrode (cell A) was made using a paste having the following composition (expressed in wt % with respect to the weight of the paste):

| | |
|---|---|
| electrochemically active material | 92.7% |
| CoO conductive material | 8% |
| PTFE binder | 1% |
| thickener | 0.3% |

The powdered electrochemically active material was a nickel-based hydroxide. The binder was polytetrafluoroethylene (PTFE). The thickener was the sodium salt of hydroxypropylmethylcellulose (HPMC). The viscosity of the paste was adjusted with water. The paste was introduced into a conductive support serving as a current collector in the form of a nickel foam with a porosity of approximately 95%. When the paste had been introduced into the support, the resulting combination was dried to eliminate water and then rolled to obtain the thickness required for the electrode.

The second positive electrode (cell C) was made with a paste having the following composition (expressed in wt % with respect to the weight of the paste):

| | |
|---|---|
| electrochemically reactive material | 92.7% |
| CoO conductive material | 8% |
| EVA binder | 0.5% |
| SBR binder | 0.2% |
| thickener | 0.3% |

The powdered electrochemically active material was a nickel-based hydroxide. The thickener was the sodium salt of hydroxypropylmethylcellulose (HPMC). The viscosity of the paste was adjusted with water. The paste was deposited simultaneously on both sides of a two-dimensional metal support (perforated nickel-plated steel 70 microns thick) in a homogeneous manner. The resulting assembly was then dried for 30 minutes at 80° C. to eliminate the water and then rolled to the thickness required for the electrode.

The third positive electrode (cell D) was made with a paste having the following composition (expressed in wt % with respect to the weight of the paste):

| | |
|---|---|
| electrochemically active material | 92.7% |
| CoO conductive material | 8% |
| EVA binder | 3% |
| SBR binder | 1% |
| thickener | 0.3% |

The powdered electrochemically active material was a nickel-based hydroxide. The thickener was the sodium salt of hydroxypropylmethylcellulose (HPMC). The viscosity of the paste was adjusted with water. The paste was deposited simultaneously on both sides of a two-dimensional metal support (perforated nickel-plated steel 70 microns thick) in a homogeneous manner. The resulting assembly was then dried for 30 minutes at 80° C. to eliminate water and then rolled to the thickness required for the electrode.

The prior art negative electrode used for the electrochemically active material includes an intermetallic compound capable of forming a hydride when charged. Its capacity was higher than that of the positive electrode. Each positive electrode was placed back-to-back with a negative electrode from which it was isolated by a non-woven polypropylene separator to form the electrode assembly. The coiled electrode assembly was inserted into a metal container and impregnated with an alkaline electrolyte in the form of an aqueous alkaline solution comprising a mixture of 7.5N potassium hydroxide KOH, 0.5N lithium hydroxide LiOH, and 0.4N sodium hydroxide NaOH to form the cells A, B, C, D.

After resting for 48 hours, the storage cells were electrically formed under the following conditions:

Rest for 2 hours at 85° C.

Cycle 1:

Charge for 8 hours at 0.1 Ic and 85° C., where Ic is the current necessary to discharge the nominal capacity Cn of the cell in 1 hour,

Rest for 4 hours at 20° C.,

Charge for 3 hours at 0.33 Ic,

Discharge for 1 hour at 0.66 Ic,

Charge for 1 hour at Ic and 1 hour 1 2 minutes at 0.5 Ic,

Discharge at 0.2 Ic to a stopping voltage of 0.9 volt;

Cycles 2 to 10

Charge for 16 hours at 0.1 Ic and 20° C.,

Discharge at 0.2 Ic to a stopping voltage of 0.9 volt.

The table below sets out the electrical performance of the various cells:

TABLE

| Cell: | A | B | C | D |
|---|---|---|---|---|
| Electrochemical efficiency of the | 255 | 250 | 235 | 200 |
| positive electrodes during cycle 10 | | | | |
| (mAh/g) | | | | |

The above results show that the cell B according to the invention had performance equivalent to the reference cell A. When the total amount of binder was 0.7 wt % (cell C), the electrical performance was worse, probably because of imperfect mechanical strength of the electrode. When the total amount of binder was 4 wt % (cell D), the electrical performance was worse, probably because of a high level of covering of the active material particles.

The electrode of cell B according to the invention thus had electrical performance comparable to that of a three-dimensional collector PTFE electrode, combined with the cost advantages of a two-dimensional collector and improved cohesion and adhesion compared to fluoropolymer binder electrodes.

There is claimed:

1. A non-sintered electrode including a metal two-dimensional conductive support and a paste comprising an electrochemically active material containing nickel hydroxide and a binder which is a mixture of an elastomer consisting of a butadiene polymer and an ethylene/vinyl acetate copolymer.

2. The electrode claimed in claim 1 wherein the total proportion of binder is from 1 wt % to 3 wt %.

3. The electrode claimed in claim 1 wherein the proportion of butadiene copolymer in said binder is from 10 wt % to 60 wt % and the proportion of ethylene/vinyl acetate copolymer in said binder is from 40 wt % to 90 wt %.

4. The electrode claimed in claim 1 wherein said butadiene copolymer is a carboxylated styrene/butadiene copolymer.

5. The electrode claimed in claim 1 wherein said electrochemically active material containing nickel hydroxide contains an element chosen from zinc, cadmium and magnesium.

6. The electrode claimed in claim 1 wherein said electrochemically active material containing nickel hydroxide contains an element chosen from cobalt, manganese, aluminum, yttrium, calcium, strontium, zirconium, copper, lithium and sodium.

7. The electrode claimed in claim 1 wherein said nickel hydroxide is spheroidal and has a particle size range from 7 microns to 20 microns.

8. The electrode claimed in claim 1 wherein said paste further contains a powdered yttrium compound.

9. The electrode claimed in claim 8 wherein said powder is yttrium oxide or yttrium hydroxide.

10. The electrode claimed in claim 1 wherein said paste further contains a conductive material consisting essentially of a cobalt compound.

11. The electrode claimed in claim 10 wherein said compound is chosen from cobalt oxide, metallic cobalt and cobalt hydroxide.

12. The electrode claimed in claim 1 further including a powder chosen from zinc oxide and zinc hydroxide.

13. An alkaline electrolyte secondary storage cell including an electrode as claimed in any preceding claim.
